(19) United States
(12) Patent Application Publication
(10) Pub. No.: US 2024/0345464 A1
(43) Pub. Date: Oct. 17, 2024

(54) PHOSPHOR WHEEL

(71) Applicant: Panasonic Intellectual Property Management Co., Ltd., Osaka (JP)

(72) Inventors: Noboru IIZAWA, Osaka (JP); Yosuke HONDA, Nara (JP)

(21) Appl. No.: 18/293,687

(22) PCT Filed: Aug. 17, 2022
(86) PCT No.: PCT/JP2022/031138

§ 371 Date: Jan. 30, 2024

(30) Foreign Application Priority Data
Aug. 31, 2021 (JP) 2021-141836

(51) Int. Cl. G03B 21/20; G02B 26/00; G03B 21/16

(52) U.S. Cl. CPC G03B 21/204; G02B 26/008; G03B 21/16

(57) ABSTRACT

A phosphor wheel includes: a substrate having a first main surface and a second main surface; a phosphor layer provided on the first main surface; and a heat dissipation member disposed opposite the second main surface. The heat dissipation member includes: a protrusion provided in a central part of the heat dissipation member; and a plurality of fins formed by lancing a plurality of regions in a peripheral region outside the central part. The protrusion provides a set gap between the substrate and the heat dissipation member and conducts heat from the substrate to the peripheral region. Two fins among the plurality of fins are formed on sides of the corresponding region opposite each other in a rotation direction of the heat dissipation member.

### CROSS-REFERENCE OF RELATED APPLICATIONS

This application is the U.S. National Phase under 35 U.S.C. § 371 of International Patent Application No. PCT/JP2022/031138, filed on Aug. 17, 2022, which in turn claims the benefit of Japanese Patent Application No. 2021-141836, filed on Aug. 31, 2021, the entire disclosures of which Applications are incorporated by reference herein.

### TECHNICAL FIELD

The present disclosure relates to a phosphor wheel.

### BACKGROUND ART

A phosphor wheel that emits light using laser light (excitation light) emitted from a laser light source is known as a light source device employed in laser projectors and the like. To suppress degradation caused by a phosphor layer emitting heat when irradiated with the laser light, the phosphor wheel is rotated about a rotation axis while the phosphor layer is being irradiated with the laser light.

A technique in which fins having a wing structure are formed in a gap space where two support members having phosphors disposed on both side surfaces thereof are provided opposed each other has been disclosed as a technique for improving the heat dissipation performance of the phosphor wheel (see PTL 1, for example). According to PTL 1, the discharge of heat from the phosphor can be accelerated by air, which serves as a coolant, passing through the gap space, which makes it possible to improve the heat dissipation performance of the phosphor wheel.

### CITATION LIST

### Patent Literature

### [PTL 1] Japanese Patent No. 5661947

### SUMMARY OF INVENTION

### Technical Problem

Recent years have seen even more demand for improved heat dissipation performance in phosphor wheels.

The present disclosure provides a phosphor wheel having improved heat dissipation performance.

### Solution to Problem

To achieve the above-described object, a phosphor wheel according to the present disclosure includes: a substrate having a first main surface and a second main surface which face in opposite directions; a phosphor layer provided on the first main surface; and a heat dissipation member constituted by a plate member, the heat dissipation member being disposed opposite the second main surface and rotating along with the substrate. The heat dissipation member includes: a protrusion provided in a central part of the heat dissipation member and protruding toward the second main surface, the protrusion having a contact surface that contacts the second main surface; and a plurality of fins formed by lancing a plurality of regions in a peripheral region outside the central part. The protrusion provides a set gap between the substrate and the heat dissipation member and conducts heat from the substrate to the peripheral region of the heat dissipation member by contacting the substrate with the contact surface. Two fins among the plurality of fins are formed in each of the plurality of regions, and the two fins are formed on sides, of a corresponding one of the plurality of regions, that are opposite each other in a rotation direction of the heat dissipation member.

### Advantageous Effects of Invention

The phosphor wheel of the present disclosure provides improved heat dissipation performance.

### BRIEF DESCRIPTION OF DRAWINGS

FIG. 1 is an exploded perspective view of a phosphor wheel according to Embodiment 1.

FIG. 2 is a side view of the phosphor wheel according to Embodiment 1.

FIG. 3 is a front view of a substrate according to Embodiment 1 when viewed from a first main surface side.

FIG. 4 is an enlarged side view of a heat dissipation member illustrated in FIG. 2.

FIG. 5 is a front view of the heat dissipation member according to Embodiment 1 when viewed from the first main surface side.

FIG. 6 is a perspective view of the heat dissipation member according to Embodiment 1 when viewed from the first main surface side.

FIG. 7 is an enlarged partial side view of the heat dissipation member illustrated in FIG. 5.

FIG. 8 is a diagram illustrating results of tests on a real prototype of the phosphor wheel according to Embodiment 1.

FIG. 9 is a diagram illustrating results of analyzing the flow of fluid near one fin formed in one region of a heat dissipation member according to a comparative example.

FIG. 10 is a diagram illustrating results of analyzing the flow of fluid near two fins formed on opposite sides of one region in the heat dissipation member according to Embodiment 1.

FIG. 11A is an example of an enlarged front view of a heat dissipation member according to Variation 1.

FIG. 11B is an example of an enlarged front view of the heat dissipation member according to Variation 1.

FIG. 12A is an example of an enlarged front view of a heat dissipation member according to Variation 2.

FIG. 12B is an example of an enlarged front view of the heat dissipation member according to Variation 2.

FIG. 13A is an example of an enlarged perspective view of a protrusion according to Variation 3 when viewed from the first main surface side.

FIG. 13B is an example of an enlarged perspective view of the protrusion according to Variation 3 when viewed from the first main surface side.

FIG. 14A is an example of a partial enlarged side view of a heat dissipation member and a substrate according to Variation 4.

FIG. 14B is an example of a partial enlarged side view of the heat dissipation member and the substrate according to Variation 4.

FIG. 14C is an example of a partial enlarged side view of the heat dissipation member and the substrate according to Variation 4.

FIG. 15A is an enlarged view of a fin formed in one region of a heat dissipation member according to Embodiment 2.

FIG. 15B is a diagram illustrating an example of the planar shape of the fin according to Embodiment 2.

FIG. 16A is an enlarged view of a fin formed in one region of a heat dissipation member according to a variation on Embodiment 2.

FIG. 16B is a diagram illustrating an example of the planar shape of the fin according to the variation on Embodiment 2.

### DESCRIPTION OF EMBODIMENTS

Embodiments of the present disclosure will be described hereinafter with reference to the drawings. The following embodiments describe specific preferred examples of the present disclosure. As such, the numerical values, shapes, materials, constituent elements, arrangements of constituent elements, connection states, and the like in the following embodiments are merely examples, and are not intended to limit the present disclosure. Thus, of the constituent elements in the following embodiments, constituent elements not denoted in the independent claims, which express the broadest interpretation of the present disclosure, will be described as optional constituent elements.

Note also that the drawings are schematic diagrams, and are not necessarily exact illustrations. Also, configurations that are substantially the same are given the same reference signs in the drawings, and redundant descriptions will be omitted or simplified.

Coordinate axes may be indicated in the drawings referenced in the following embodiments. “Z-axis direction” will be used to refer to a height direction of the phosphor wheel. “Z-axis+side” may be used to refer to an upper side (upward), and “Z-axis−side” may be used to refer to a lower side (downward). “X-axis direction” and “Y-axis direction” are directions orthogonal to each other on a plane perpendicular to the Z-axis direction. In the following embodiments, “front view” refers to a drawing viewed from the X-axis+side, and “rear view” refers to a drawing viewed from the X-axis-side. “Side view” refers to a drawing viewed from the Y-axis direction.

### Embodiment 1

### Phosphor Wheel 1

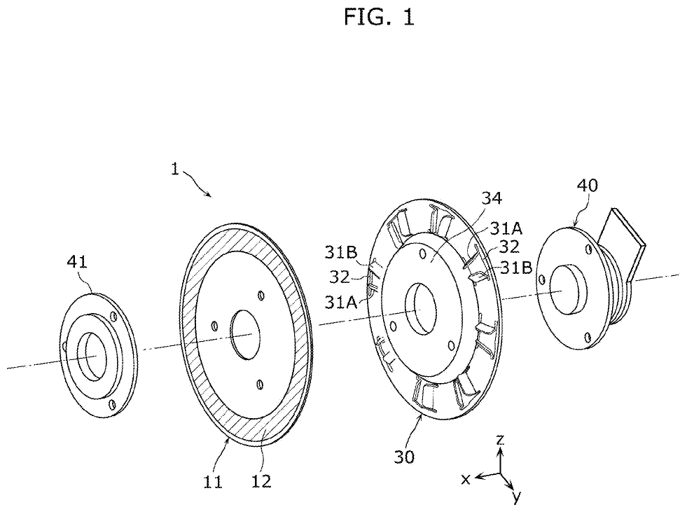

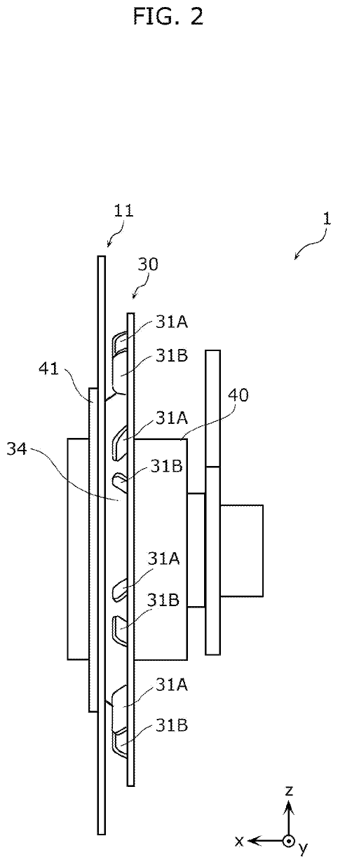

The configuration of phosphor wheel 1 according to Embodiment 1 will be described hereinafter with reference to FIGS. 1 and 2. FIG. 1 is an exploded perspective view of phosphor wheel 1 according to Embodiment 1. FIG. 2 is a side view of phosphor wheel 1 according to Embodiment 1.

Phosphor wheel 1 according to Embodiment 1 is a reflective phosphor wheel, and is used as a light source in a laser projector or the like. As illustrated in FIGS. 1 and 2, phosphor wheel 1 includes substrate 11, phosphor layer 12 provided on substrate 11, heat dissipation member 30, motor 40, and adjustment plate 41. Adjustment plate 41 is used to adjust shifts in the center of gravity during rotation in order to transmit rotational drive power from motor 40 to substrate 11 or the like in a balanced manner, but adjustment plate 41 is not a necessary element. Adjustment plate 41 may be a hub of motor 40.

### Substrate 11

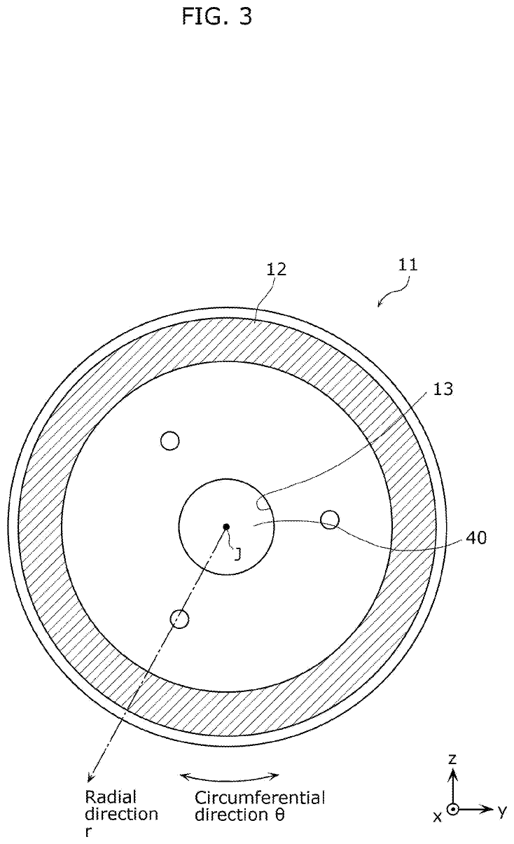

FIG. 3 is a front view of substrate 11 according to Embodiment 1 when viewed from a first main surface side.

Substrate 11 is a disk-shaped plate member having a first main surface and a second main surface that face in opposite directions, and is rotationally driven by motor 40 about rotation axis J. In other words, the shape of substrate 11 is circular when seen in plan view. Note that “shape in plan view” refers to the shape as seen from the direction perpendicular to substrate 11 (the X-axis+side) (i.e., the front shape). The diameter of substrate 11 is about 5 cm or less, for example, but is not particularly limited.

As illustrated in FIG. 3, phosphor layer 12 is provided on the first main surface of substrate 11. Opening 13, from which a part of motor 40 (a hub, a rotor, or the like) coupled to adjustment plate 41 protrudes, is provided in the center of substrate 11. Substrate 11 is rotationally driven by motor 40 about rotation axis J, with rotation axis J passing through the center (center position) thereof.

The material of substrate 11 is not particularly limited as long as it is a metal having good thermal conductivity, such as aluminum, stainless steel, sapphire, or the like. In the present embodiment, substrate 11 is formed from aluminum, for example. Aluminum has a relatively high thermal conductivity and is lightweight, and thus forming substrate 11 from aluminum makes it possible to not only improve heat dissipation performance, but also reduce weight. Substrate 11 is no thicker than 1.5 mm, for example.

### Phosphor Layer 12

Phosphor layer 12 is provided on the first main surface of substrate 11.

Here, phosphor layer 12 may be constituted by a resin material containing a large number of YAG-based yellow phosphor particles, for example. In this case, the substrate formed from the resin material is, for example, a silicone resin having light transmittance and thermosetting properties. Phosphor layer 12 can be provided by screen-printing such a resin material onto the first main surface of substrate 11 and then heating and setting the material in a heating furnace.

Phosphor layer 12 may also be constituted by YAG-based yellow phosphor particles and a binder, for example. In this case, in phosphor layer 12, providing a large amount of YAG-based yellow phosphor particles that contribute to converting excitation light to fluorescence is better from the standpoint of improving light conversion efficiency. In other words, in phosphor layer 12, a higher phosphor particle content ratio is better. The binder is a mixture aside from the yellow phosphor particles constituting phosphor layer 12. The binder is formed from an inorganic substance having a high thermal conductivity, such as alumina, for example. The thermal conductivity of alumina is more than 10 times that of silicone resin. Accordingly, phosphor layer 12 can be constituted by yellow phosphor particles and a binder formed from alumina to achieve a high thermal conductivity.

Although not illustrated in FIGS. 1 to 3, a reflective film may be provided between the first main surface of substrate 11 and phosphor layer 12.

In the present embodiment, phosphor layer 12 is provided in a ring shape (annular shape) that forms a band along circumferential direction θ of the disk-shaped substrate 11 when seen in plan view, as illustrated in FIG. 3. More specifically, phosphor layer 12 is provided in a ring shape (annular shape) over a circle that keeps a constant distance from rotation axis J, which is the rotational center of phosphor wheel 1. In other words, a width of phosphor layer 12 in radial direction r is constant. Furthermore, it is desirable that phosphor layer 12 be provided at the peripheral edge of the first main surface. Note that even if substrate 11 is not a disk-shaped substrate, it is preferable that phosphor layer 12 have an annular shape.

Incidentally, phosphor layer 12 emits light when irradiated with laser light. To avoid focusing the laser light on one point of phosphor layer 12, phosphor wheel 1 is rotated about rotation axis J by motor 40 while phosphor layer 12 is being irradiated with the laser light. This suppresses degradation of the phosphor particles in phosphor layer 12 caused by heat emitted in response to the laser light irradiation.

### Heat Dissipation Member 30

Heat dissipation member 30 is constituted by a plate member, is disposed opposite either the first main surface or the second main surface of substrate 11, and is rotated along with substrate 11. In the example illustrated in FIGS. 1 and 2, heat dissipation member 30 is disposed opposite the second main surface of substrate 11. Phosphor layer 12 is provided on the first main surface of substrate 11.

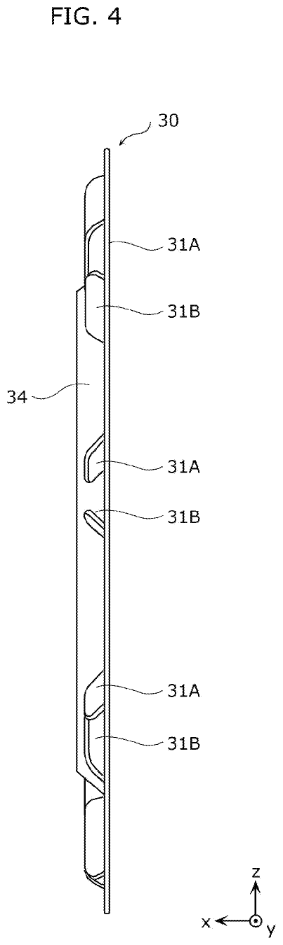

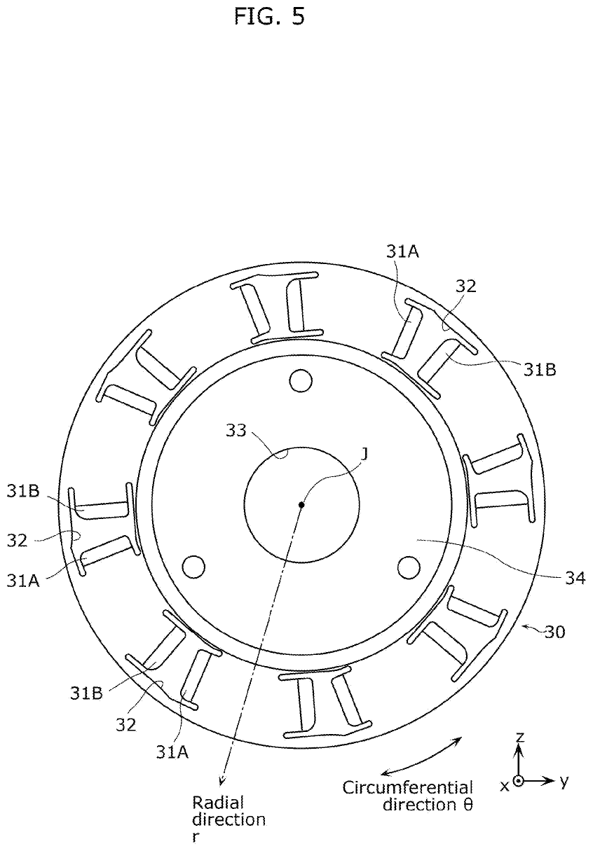

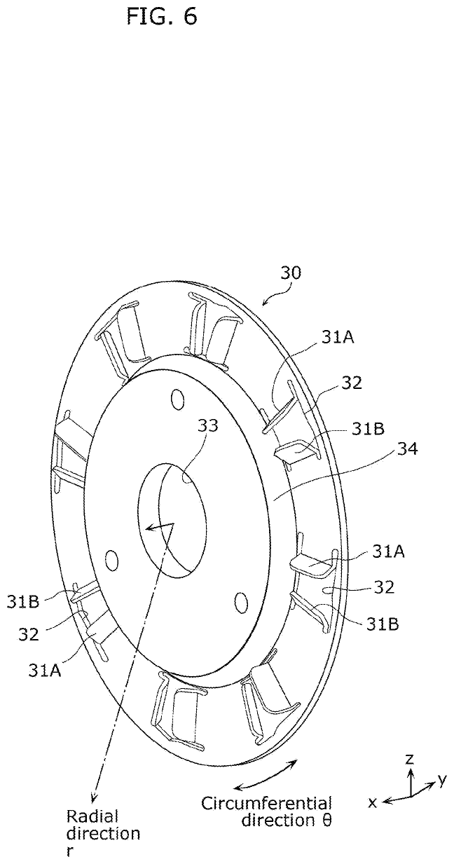

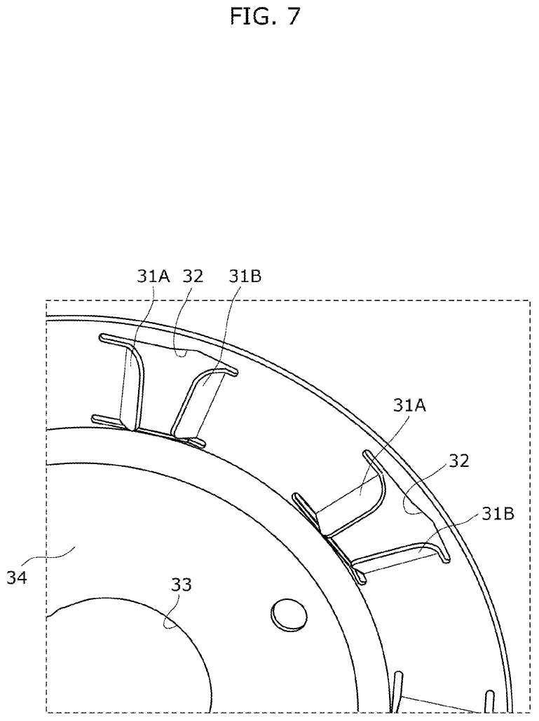

FIG. 4 is an enlarged side view of heat dissipation member 30 illustrated in FIG. 2. FIG. 5 is a front view of heat dissipation member 30 according to Embodiment 1 when viewed from the first main surface side. FIG. 6 is a perspective view of heat dissipation member 30 according to Embodiment 1 when viewed from the first main surface side. FIG. 7 is an enlarged partial side view of the heat dissipation member illustrated in FIG. 5. Note that “rear surface” is a surface opposite the surface opposite the second main surface of substrate 11 (a front surface), and a surface visible when heat dissipation member 30 is viewed from a direction perpendicular to heat dissipation member 30 (i.e., the X-axis−side).

Heat dissipation member 30 is a disk-shaped plate member rotationally driven by motor 40 about rotation axis J. In other words, the shape of heat dissipation member 30 is circular when seen in plan view. Note that although the diameter of heat dissipation member 30 is about 5 cm, for example, heat dissipation member 30 may be formed at any diameter in the range of 3 cm to 80 cm, as long as the diameter is about the same or smaller than the diameter of substrate 11. The diameter of heat dissipation member 30 may be smaller than the outer diameter of phosphor layer 12 and larger than the inner diameter of phosphor layer 12 when heat dissipation member 30 is disposed opposite the second main surface of substrate 11, but is not limited thereto. The diameter of heat dissipation member 30 may be greater than the outer diameter of phosphor layer 12. For example, the diameter of heat dissipation member 30 may be smaller than the inner diameter of phosphor layer 12 when heat dissipation member 30 is disposed opposite the first main surface of substrate 11.

In the present embodiment, heat dissipation member 30 has a plurality of fins 31A and 31B and protrusion 34, as illustrated in FIGS. 1, 2, and 4 to 7. For example, as illustrated in FIGS. 1 and 2, heat dissipation member 30 is disposed opposite the second main surface of substrate 11. The plurality of fins 31A and 31B are flared toward the second main surface of substrate 11, and protrusion 34 also protrudes toward the second main surface of substrate 11. More specifically, the plurality of fins 31A and 31B are formed by lancing a plurality of regions 32, which are a plurality of partial regions of the plate member in heat dissipation member 30. The plurality of regions 32 become through-holes after the plurality of fins 31A and 31B are formed. The plurality of regions 32 function as vent holes when heat dissipation member 30 is rotated with substrate 11. Protrusion 34, the plurality of fins 31A and 31B, region 32, and the like will be described in detail later.

The material of heat dissipation member 30 may be, but is not particularly limited to, a metal plate material such as stainless steel, iron, copper, sapphire, or aluminum, for example.

### Protrusion 34

Protrusion 34 is provided in the central part of heat dissipation member 30 so as to protrude toward either the first main surface or the second main surface of substrate 11, and has a contact surface that contacts the stated main surface. By contacting substrate 11 with the contact surface, protrusion 34 provides a set gap between substrate 11 and heat dissipation member 30, and conducts heat from substrate 11 to a peripheral region outside the central part of heat dissipation member 30.

In the present embodiment, protrusion 34 is provided in a central part of heat dissipation member 30 so as to protrude toward the second main surface of substrate 11 and maintain a constant gap between substrate 11 and heat dissipation member 30, as illustrated in FIG. 2, for example. Protrusion 34 is formed through a drawing process.

The thickness of protrusion 34, i.e., the gap between substrate 11 and heat dissipation member 30, may be any thickness greater than or equal to the height of the plurality of fins 31A and 31B formed in the peripheral region of heat dissipation member 30 (described later), as illustrated in FIG. 2. As illustrated in FIGS. 5 and 6, for example, protrusion 34 has a band-shaped and annular-shaped contact surface for contacting the second main surface of substrate 11.

Opening 33 is provided in the center of protrusion 34, and is connected to motor 40 through adjustment plate 41. Through this, heat dissipation member 30 is, along with substrate 11, rotationally driven by motor 40 about rotation axis J, with rotation axis J passing through the center (center position) thereof. Note that the size (diameter) of opening 33 may be any size as long as the size is large enough for a part of motor 40 for coupling with adjustment plate 41 to protrude therefrom. For example, opening 33 may be any size providing a gap of up to 1 mm from the part of motor 40.

The diameter of protrusion 34 is not particularly limited as long as the diameter is smaller than the inner diameter of heat dissipation member 30 and larger than the diameter of opening 33.

In this manner, protrusion 34 is provided in a central part of heat dissipation member 30 so as to have a band-shaped and annular-shaped contact surface, as illustrated in FIGS. 1, 2, and 4 to 6. As a result, protrusion 34 functions not only as a spacer that can form a set gap (space) of air between substrate 11 and the peripheral region of heat dissipation member 30, but also as a heat conduction path that can conduct heat produced in phosphor layer 12 from substrate 11 to the peripheral region of heat dissipation member 30.

### Fins 31A and 31B

The plurality of fins 31A and 31B are formed through a lancing process. More specifically, the plurality of fins 31A and 31B are formed by lancing the plate member of heat dissipation member 30 in the plurality of regions 32 located in the peripheral region outside the central part. Each of the plurality of fins 31A and 31B is flared toward either the first main surface or the second main surface of substrate 11.

In the present embodiment, the plurality of fins 31A and 31B are erected in the direction of the second main surface of substrate 11 by the plurality of regions 32 being flared toward the second main surface of substrate 11, as illustrated in FIGS. 1, 2, and 4, for example. The height of the plurality of fins 31A and 31B is less than the thickness of protrusion 34, as illustrated in FIGS. 2 and 4.

Furthermore, in the present embodiment, two fins 31A and 31B are formed in each of the plurality of regions 32, and the two fins 31A and 31B are formed on sides of the corresponding region 32 opposite each other in a rotation direction of heat dissipation member 30 (opposite sides). Here, in the example illustrated in FIGS. 5 to 7, one of the two fins 31A and 31B has substantially the same size as the other. In other words, the two fins 31A and 31B have substantially the same width in the direction parallel to the opposite sides of region 32. The two fins 31A and 31B are formed by lancing each of the plurality of regions 32, with the opposite sides in each of the plurality of regions 32 being bent and erected opposite each other.

The plurality of fins 31A and 31B are disposed in an annular shape in the peripheral region of heat dissipation member 30 along circumferential direction θ at a constant distance from the center (rotation axis J), as illustrated in FIGS. 5 to 7, for example. The shape of the plurality of fins 31A and 31B may be substantially rectangular (substantially trapezoidal), for example, but the corners of the ends thereof may be rounded off. In other words, as illustrated in FIGS. 5 to 7, each of the plurality of fins 31A and each of the plurality of fins 31B are formed so as to have a constant angle relative to radial direction r in the peripheral region, and are lanced so as to have a constant angle relative to the second main surface of substrate 11 (or the front surface of heat dissipation member 30). Note that it is sufficient for each of the plurality of fins 31A and 31B to be formed in the peripheral region, and the fins need not be formed along radial direction r. Each of the plurality of fins 31A and 31B need not be erected perpendicular to the second main surface of substrate 11 (or the front surface of heat dissipation member 30).

Incidentally, in the present embodiment, each of the plurality of fins 31A and 31B pushes wind outward from fins 31A and 31B (in the centrifugal direction) as heat dissipation member 30 rotates about rotation axis J. In other words, each of the plurality of fins 31A and 31B pushes air (a fluid) on the rear side (the X-axis−side) of heat dissipation member 30 out of the plurality of regions 32, which are through-holes, toward the outside of the space between substrate 11 and heat dissipation member 30. As such, wind (airflow), which is the flow of air produced by the plurality of fins 31A and 31B, can be used to cool phosphor layer 12.

Note that the angle of fins 31A and 31B with respect to radial direction r and the angle of fins 31A and 31B with respect to the second main surface are not limited to the examples illustrated in FIGS. 1, 2, and 3 to 7 as long as wind can be pushed outward effectively.

A plurality of holes may also be formed in each of fins 31A and 31B. The number, positions, shapes, and sizes of the plurality of holes provided in fins 31A and 31B may be determined as appropriate and are not limited.

### Region 32

As described above, two fins 31A and 31B are formed in each of the plurality of regions 32. Region 32 is a partial region in the plate member of heat dissipation member 30 and becomes a through-hole after the two fins 31A and 31B are formed.

More specifically, the plurality of regions 32 are located in the peripheral region outside the central part of heat dissipation member 30. Furthermore, the plurality of regions 32 may be similar shapes, but are not limited to being similar shapes.

As illustrated in FIGS. 5 to 7, the plurality of regions 32 are through-holes that penetrate through heat dissipation member 30. The plurality of regions 32 function as vent holes through which wind produced by the plurality of fins 31A and 31B passes when heat dissipation member 30 is rotated with substrate 11. The plurality of regions 32 are located in the peripheral region, in an annular shape following circumferential direction θ at a constant distance from the center of heat dissipation member 30 (rotation axis J), as illustrated in FIG. 5, for example.

If the plurality of regions 32 are arranged at random, the rotation of heat dissipation member 30 destabilizes and produces abnormal sounds and the like, and the plurality of regions 32 are therefore arranged at substantially equal intervals. The shape of the plurality of regions 32 may be substantially rectangular (substantially trapezoidal), for example, but the corners thereof may be rounded off.

Additionally, each of the plurality of regions 32 need not be formed along radial direction r.

### Motor 40

As illustrated in FIG. 1, for example, motor 40 is controlled by electronic circuitry (not shown) to rotationally drive substrate 11 and heat dissipation member 30. Motor 40 may be, for example, an outer rotor-type motor, but is not particularly limited.

### Effects, Etc.

As described above, phosphor wheel 1 according to the present embodiment includes: substrate 11 having a first main surface and a second main surface which face in opposite directions; phosphor layer 12 provided on the first main surface; and heat dissipation member 30 constituted by a plate member, heat dissipation member 30 being disposed opposite the second main surface of substrate 11 and rotating along with substrate 11. Heat dissipation member 30 includes: protrusion 34 provided in a central part of heat dissipation member 30 and protruding toward the second main surface, protrusion 34 having a contact surface that contacts the second main surface; and a plurality of fins 31A and 31B formed by lancing a plurality of regions 32 in a peripheral region outside the central part. Protrusion 34 provides a set gap between substrate 11 and heat dissipation member 30 and conducts heat from substrate 11 to the peripheral region of heat dissipation member 30 by contacting substrate 11 with the contact surface. Two fins 31A and 31B are formed in each of the plurality of regions 32. The two fins 31A and 31B are formed on sides of region 32 opposite each other (opposite sides) in the rotation direction of heat dissipation member 30.

In this manner, phosphor wheel 1 according to the present embodiment is a reflective phosphor wheel, and includes phosphor layer 12 only on the first main surface of substrate 11. Furthermore, in phosphor wheel 1, by including heat dissipation member 30 provided with protrusion 34, a space providing a set gap can be formed between substrate 11 and heat dissipation member 30. As a result, wind produced by the plurality of fins 31A and 31B can be pushed out of the plurality of regions 32 (through-holes) toward the outside of the space between substrate 11 and heat dissipation member 30. In other words, wind produced by the plurality of fins 31A and 31B can be used to cool phosphor layer 12.

Furthermore, in phosphor wheel 1, having substrate 11 and protrusion 34 contact each other makes it possible to form a heat conduction path that conducts heat produced in phosphor layer 12 from substrate 11 to the peripheral region of heat dissipation member 30, which improves the heat dissipation performance.

Furthermore, in the present embodiment, the two fins 31A and 31B are formed on opposite sides of the corresponding one of the plurality of regions 32, and thus the area of the plurality of fins located near the surface of substrate 11 increases. This accelerates the dissipation of heat due to convection on substrate 11, which makes it possible to reduce the temperature of phosphor layer 12. The heat dissipation performance of phosphor wheel 1 can therefore be improved.

Although the size of opening 33 provided in the center of heat dissipation member 30 has been described as being sufficient as long as the size is large enough for a part of motor 40 for coupling with adjustment plate 41 to protrude therefrom, the size is not limited thereto. The size of opening 33 may be increased and used for ventilation. In other words, heat dissipation member 30 may include opening 33 formed for ventilation in a central part of heat dissipation member 30, and rotation axis J of heat dissipation member 30, which rotates with substrate 11, may pass through opening 33.

As a result, wind produced by the plurality of fins 31A and 31B can be pushed not only from the plurality of regions 32 (through-holes), but also from opening 33, toward the outside of the space (the gap) between substrate 11 and heat dissipation member 30. This makes it possible to increase the amount of wind, which can be used to cool phosphor layer 12, that passes through the space between substrate 11 and heat dissipation member 30, which makes it possible to improve the heat dissipation performance of phosphor wheel 1.

Note that the configuration of phosphor wheel 1 is not limited to that described above, and fins may be formed in substrate 11, or openings may be formed in substrate 11 as through-holes, in order to further improve the heat dissipation performance.

Test results obtained by creating prototypes of and testing an actual phosphor wheel 1 according to the present embodiment, configured as described above, will be described hereinafter.

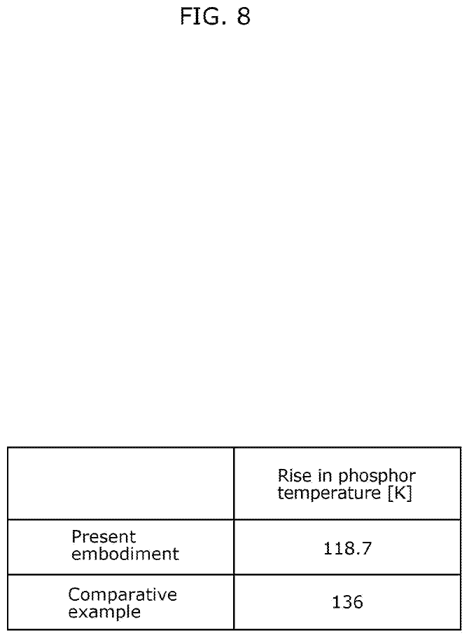

FIG. 8 is a diagram illustrating results of tests on a real prototype of phosphor wheel 1 according to Embodiment 1. FIG. 8 illustrates a rise in the temperature of phosphor layer 12 after operation for a predetermined time as a test result. Note that as a comparative example, FIG. 8 also illustrates test results for a real prototype of phosphor wheel 1 having a configuration in which only one fin is formed in each of a plurality of regions of the heat dissipation member.

From FIG. 8, it can be seen that the rise in the temperature of phosphor layer 12 of phosphor wheel 1 according to Embodiment 1 (118.7 [K]) is lower than the rise in temperature of phosphor layer 12 of phosphor wheel 1 according to the comparative example (136 [K]).

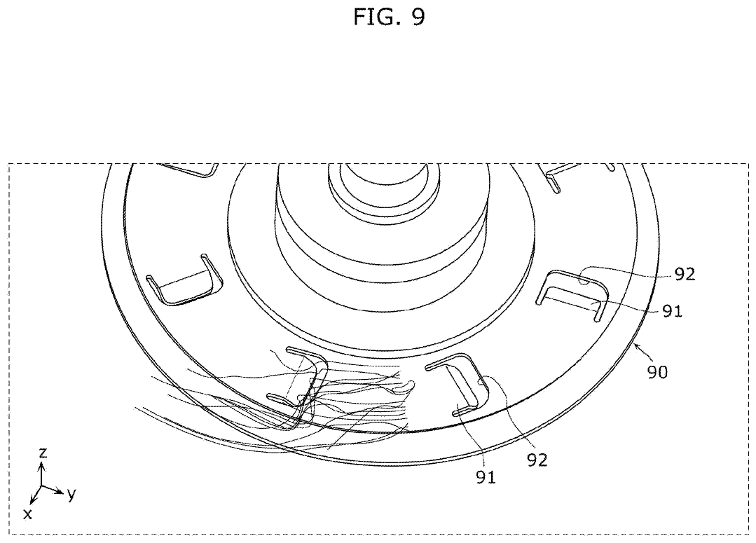

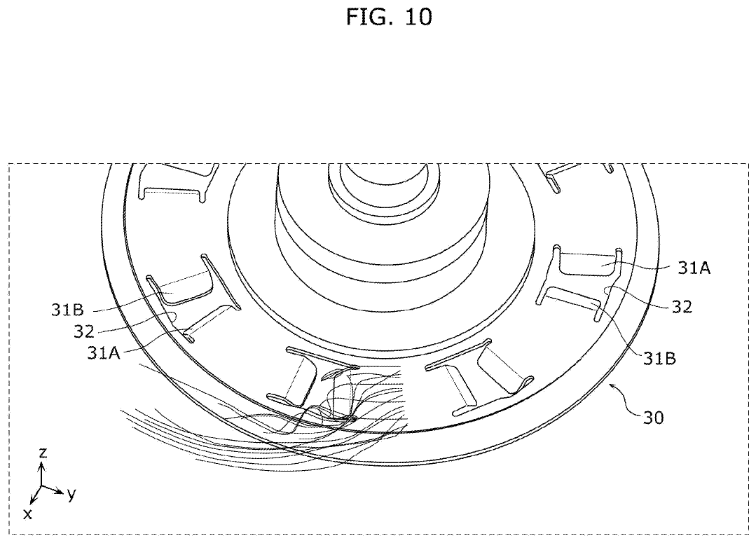

FIG. 9 is a diagram illustrating results of analyzing the flow of fluid near one fin 91 formed in one region 92 of heat dissipation member 90 according to a comparative example. FIG. 9 uses flow lines to indicate the flow of the fluid (air) passing through region 92, which functions as a vent hole, toward fin 91. FIG. 10 is a diagram illustrating results of analyzing the flow of fluid near the two fins 31A and 31B formed on opposite sides of one region 32 in heat dissipation member 30 according to Embodiment 1. FIG. 10 uses flow lines to indicate the flow of the fluid (air) passing through region 32, which functions as a vent hole, toward fins 31A and 31B. Note that the vector lines indicated in FIGS. 9 and 10 express the flow of the fluid (air).

For example, the fins 31A and 31B illustrated in FIG. 10 have a function for bringing out a fluid (air) present in a region interposed between a planar part of heat dissipation member 30 and substrate 11 (see FIGS. 1 and 2, for example) in an outward peripheral direction of heat dissipation member 30. Using this function, phosphor wheel 1 according to Embodiment 1 accelerates the transfer of heat through convection, which makes it possible to reduce the temperature of phosphor layer 12 provided on substrate 11. Additionally, the fluid flowing from region 32, which functions as a vent hole, toward fins 31A and 31B also makes contact with fins 31A and 31B, and is therefore drawn out to the outer periphery of heat dissipation member 30 thereafter. This also helps accelerate the transfer of heat.

FIGS. 9 and 10 will be compared here. With heat dissipation member 30 illustrated in FIG. 10 according to Embodiment 1, in which two fins 31A and 31B are formed on opposite sides of each of the plurality of regions 32, it can be seen that the fluid is smoothly pushed out to the outer periphery of heat dissipation member 30 and the dissipation of heat is being accelerated through convection. On the other hand, with heat dissipation member 90 illustrated in FIG. 9 according to the comparative example, in which one fin 91 is formed in each of the plurality of regions 92, it can be seen that the fluid stagnates near fin 91, and the dissipation of heat through convection is not accelerated as much as the case illustrated in FIG. 10.

In other words, it can be seen from FIGS. 9 and 10 that forming the two fins 31A and 31B on opposite sides of each of the plurality of regions 32 can accelerate the flow of fluid produced between phosphor layer 12 and heat dissipation member 30 more than when a single fin is formed in each of the plurality of regions 32. The heat dissipation performance of phosphor wheel 1 can therefore be improved.

### Variation 1

Although the foregoing Embodiment 1 described the sizes of the two fins 31A and 31B formed in each of the plurality of regions 32 as being substantially the same, the configuration is not limited thereto. One of the two fins may be larger than the other of the two fins. An example of this case will be described hereinafter as Variation 1. The following descriptions will focus on the differences from heat dissipation member 30 described in Embodiment 1.

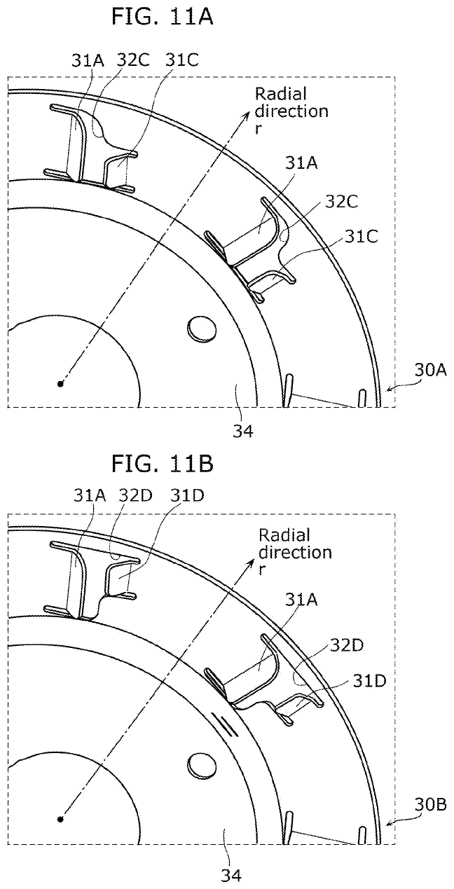

FIGS. 11A and 11B are examples of an enlarged front view of the heat dissipation member according to Variation 1. Note that elements identical to those in FIG. 7 and the like are given the same reference signs and will not be described in detail.

FIG. 11A illustrates an example in which two fins 31A and 31C are formed on the respective opposite sides of each of a plurality of regions 32C in heat dissipation member 30A according to Variation 1. FIG. 11B illustrates an example in which two fins 31A and 31D are formed on the respective opposite sides of each of a plurality of regions 32D in heat dissipation member 30B according to Variation 1.

More specifically, as illustrated in FIG. 11A, for example, two fins 31A and 31C are formed in each of the plurality of regions 32C in heat dissipation member 30A. The two fins 31A and 31C are formed on sides of region 32C opposite each other (opposite sides) in the rotation direction of heat dissipation member 30A. One of the two fins 31A and 31C is larger than the other. In other words, the two fins 31A and 31C have different widths in the direction parallel to the opposite sides of region 32C, with fin 31C being narrower than fin 31A.

Additionally, as illustrated in FIG. 11A, fin 31C is formed in a side of region 32C located opposite to a part of the side of region 32C on which fin 31A is formed, and on the inner side thereof with respect to radial direction r of heat dissipation member 30A. The shape of fins 31A and 31C may be substantially rectangular (substantially trapezoidal), for example, but the corners of the ends thereof may be rounded off, as illustrated in FIG. 11A.

Likewise, as illustrated in FIG. 11B, for example, two fins 31A and 31D are formed in each of the plurality of regions 32D in heat dissipation member 30B. The two fins 31A and 31D are formed on sides of region 32D opposite each other (opposite sides) in the rotation direction of heat dissipation member 30B. One of the two fins 31A and 31D is larger than the other. In other words, the two fins 31A and 31D have different widths in the direction parallel to the opposite sides of region 32D, with fin 31D being narrower than fin 31A.

Additionally, as illustrated in FIG. 11B, fin 31D is formed in a side of region 32D located opposite to a part of the side of region 32D on which fin 31A is formed, and on the outer side thereof with respect to radial direction r of heat dissipation member 30B. Note that fin 31A is larger than fin 31D. The shape of fins 31A and 31D may be substantially rectangular (substantially trapezoidal), for example, but the corners of the ends thereof may be rounded off, as illustrated in FIG. 11B.

A prototype of phosphor wheel 1 according to Variation 1, configured as described above, was created and tested. As a result, it can be seen that the rise in the temperature of phosphor layer 12 of phosphor wheel 1 according to Variation 1 is lower than the rise in temperature of phosphor layer 12 of phosphor wheel 1 according to the comparative example. On the other hand, the rise in the temperature of phosphor layer 12 of phosphor wheel 1 according to Variation 1 was higher than the rise in temperature of phosphor layer 12 of phosphor wheel 1 according to Embodiment 1.

### Variation 2

Variation 1 described the size of one of the two fins formed in each of the plurality of regions 32 as being larger than the other, with the shapes of the two fins of different sizes as being substantially rectangular (substantially trapezoidal), but the configuration is not limited thereto. The shape of the smaller of the two fins need not be substantially rectangular (substantially trapezoidal), and may instead be substantially triangular.

An example of this case will be described hereinafter as Variation 2. The following descriptions will focus on the differences from heat dissipation member 30 described in Embodiment 1.

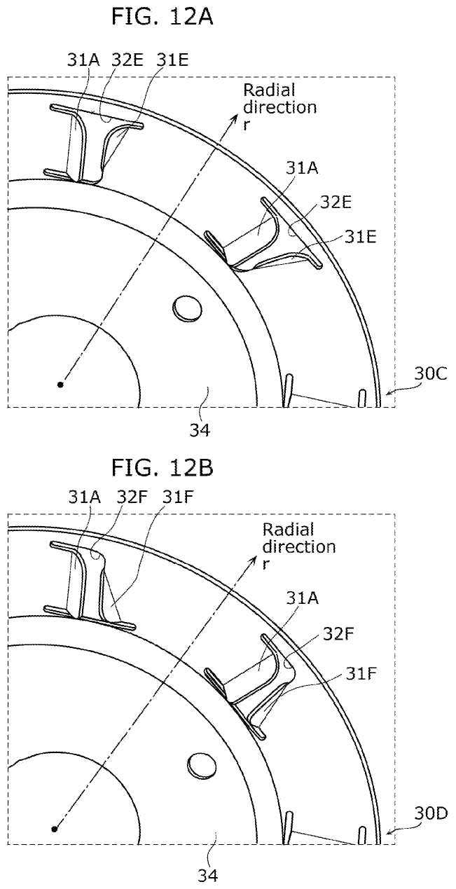

FIGS. 12A and 12B are examples of an enlarged front view of the heat dissipation member according to Variation 2. Note that elements identical to those in FIG. 7 and the like are given the same reference signs and will not be described in detail.

FIG. 12A illustrates an example in which two fins 31A and 31E are formed on the respective opposite sides of each of a plurality of regions 32E in heat dissipation member 30C according to Variation 2. FIG. 12B illustrates an example in which two fins 31A and 31F are formed on the respective opposite sides of each of a plurality of regions 32F in heat dissipation member 30D according to Variation 2.

More specifically, as illustrated in FIG. 12A, for example, two fins 31A and 31E are formed in each of the plurality of regions 32E in heat dissipation member 30C. The two fins 31A and 31E are formed on sides of region 32E opposite each other (opposite sides) in the rotation direction of heat dissipation member 30C. One of the two fins 31A and 31E is larger than the other.

Additionally, as illustrated in FIG. 12A, fin 31E is formed in a side of region 32E located opposite to a part of the side of region 32E on which fin 31A is formed, and on the outer side thereof with respect to radial direction r of heat dissipation member 30C. The shape of fin 31A may be substantially rectangular (substantially trapezoidal), for example, but the corners of the ends thereof may be rounded off, as illustrated in FIG. 12A. On the other hand, the shape of fin 31E may be substantially triangular, for example, but the corners of the ends thereof may be rounded off, as illustrated in FIG. 12A.

Likewise, as illustrated in FIG. 12B, for example, two fins 31A and 31F are formed in each of the plurality of regions 32F in heat dissipation member 30D. The two fins 31A and 31F are formed on sides of region 32F opposite each other (opposite sides) in the rotation direction of heat dissipation member 30D. One of the two fins 31A and 31F is larger than the other.

Additionally, as illustrated in FIG. 12B, fin 31F is formed in a side of region 32F located opposite to a part of the side of region 32F on which fin 31A is formed, and on the inner side thereof with respect to radial direction r of heat dissipation member 30D. The shape of fin 31A may be substantially rectangular (substantially trapezoidal), for example, but the corners of the ends thereof may be rounded off, as illustrated in FIG. 12B. On the other hand, the shape of fin 31F may be substantially triangular, for example, but the corners of the ends thereof may be rounded off, as illustrated in FIG. 12B.

A prototype of phosphor wheel 1 according to Variation 2, configured as described above, was created and tested. As a result, it can be seen that the rise in the temperature of phosphor layer 12 of phosphor wheel 1 according to Variation 2 is lower than the rise in temperature of phosphor layer 12 of phosphor wheel 1 according to the comparative example. On the other hand, the rise in the temperature of phosphor layer 12 of phosphor wheel 1 according to Variation 2 was higher than the rise in temperature of phosphor layer 12 of phosphor wheel 1 according to Embodiment 1.

### Variation 3

Embodiment 1, Variation 1, and Variation 2 described phosphor wheel 1 having improved heat dissipation performance by forming two fins in each of a plurality of regions, but the configuration for improving heat dissipation performance is not limited to the above-described configurations. To further improve the heat dissipation performance, through-holes may further be formed in the protrusion of the heat dissipation member in addition to forming two fins in each of the plurality of regions. A specific example of this case will be described hereinafter as Variation 3. The following descriptions will focus on the differences from protrusion 34 of heat dissipation member 30 described in Embodiment 1, Variation 1, and Variation 2.

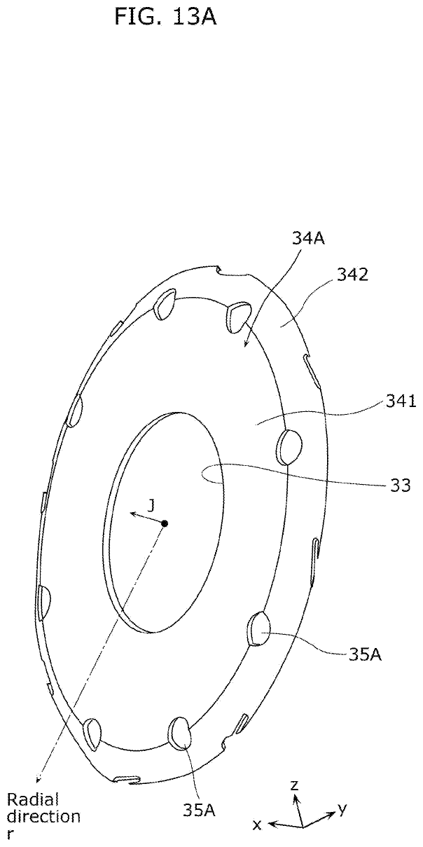

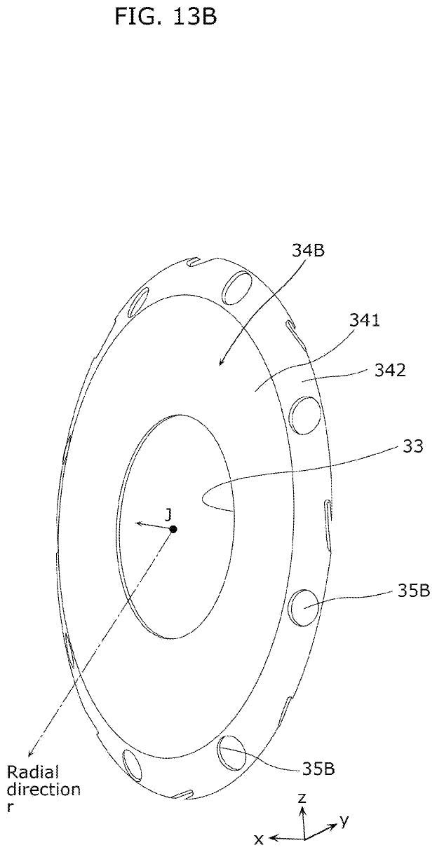

FIGS. 13A and 13B are examples of an enlarged perspective view of the protrusion according to Variation 3 when viewed from the first main surface side. Elements identical to those in FIG. 6 and the like are given the same reference signs and will not be described in detail. To facilitate descriptions of the through-holes that are formed, protrusion 34A illustrated in FIG. 13A and protrusion 34B illustrated in FIG. 13B are shown in a simplified shape compared to protrusion 34 illustrated in FIG. 6.

### Protrusion 34A

Protrusion 34A illustrated in FIG. 13A differs from protrusion 34 illustrated in FIG. 6 in that through-holes 35A are further formed therein.

More specifically, protrusion 34A illustrated in FIG. 13A is provided in the central part of heat dissipation member 30 so as to protrude toward the second main surface of substrate 11, for example, in the same manner as in Embodiment 1. Protrusion 34A is formed through a drawing process.

Protrusion 34A also has contact surface 341 that contacts the second main surface and peripheral wall 342 having contact surface 341 as a base surface.

In the present variation, protrusion 34A further has a plurality of through-holes 35A formed in peripheral wall 342 for ventilation. In other words, through-holes 35A are provided in peripheral wall 342 of protrusion 34A. More specifically, each of the plurality of through-holes 35A is formed at a boundary between peripheral wall 342 and contact surface 341, as illustrated in FIG. 13A. In other words, each of the plurality of through-holes 35A is formed across a boundary between peripheral wall 342 and contact surface 341.

Each of the plurality of through-holes 35A is formed in a different position from regions connecting rotation axis J of heat dissipation member 30 to respective ones of the plurality of fins 31A and 31B. In other words, through-holes 35A and fins 31A and 31B are formed so as not to be aligned in radial direction r.

### Protrusion 34B

Protrusion 34B illustrated in FIG. 13B differs from protrusion 34 illustrated in FIG. 6 in that through-holes 35B are further formed therein.

More specifically, protrusion 34B illustrated in FIG. 13B is provided in the central part of heat dissipation member 30 so as to protrude toward the second main surface of substrate 11, for example, in the same manner as protrusion 34A. Protrusion 34B is formed through a drawing process.

Protrusion 34B also has contact surface 341 that contacts the second main surface and peripheral wall 342 having contact surface 341 as a base surface.

In the present variation, protrusion 34B further has a plurality of through-holes 35B formed only in peripheral wall 342 for ventilation. In other words, through-holes 35B are provided in peripheral wall 342 of protrusion 34B. More specifically, each of the plurality of through-holes 35B is formed only in peripheral wall 342, as illustrated in FIG. 13B. Furthermore, each of the plurality of through-holes 35B is formed in what is the center of peripheral wall 342 when viewed in a direction from heat dissipation member 30 toward contact surface 341.

Note that like the plurality of through-holes 35A, each of the plurality of through-holes 35B is formed in a different position from regions connecting rotation axis J of heat dissipation member 30 to respective ones of the plurality of fins 31A and 31B. In other words, through-holes 35B and fins 31A and 31B are formed so as not to be aligned in radial direction r.

### Effects, Etc.

In this manner, phosphor wheel 1 according to the present variation has a configuration in which through-holes are formed in the protrusion, in addition to the two fins being formed in each of the plurality of regions as disclosed in Embodiment 1, Variation 1, or Variation 2. This makes it possible to further accelerate the flow of fluid (air) produced between phosphor layer 12 and heat dissipation member 30, which makes it possible to further reduce the temperature of phosphor layer 12. The heat dissipation performance of phosphor wheel 1 can therefore be improved even more.

### Variation 4

In Embodiment 1 to Variation 3, heat dissipation member 30 of phosphor wheel 1 is described as being a disk-shaped plate member rotationally driven by motor 40 about rotation axis J, but is not limited thereto. An outer peripheral edge of the heat dissipation member of phosphor wheel 1 according to Embodiment 1 to Variation 3 may be bent. Specific examples of this case will be described hereinafter as Variation 4. The following descriptions will focus upon the differences from heat dissipation member 30 according to Embodiment 1 to Variation 3.

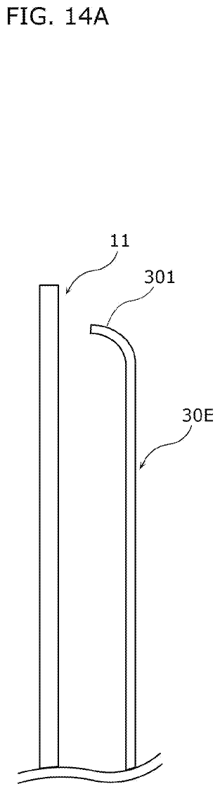

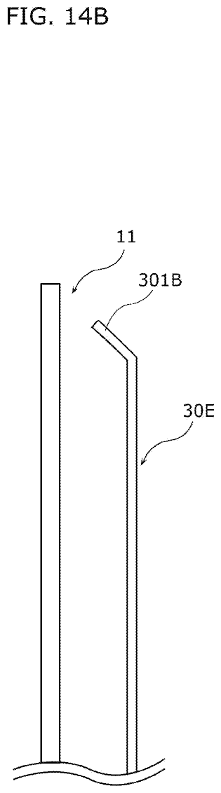

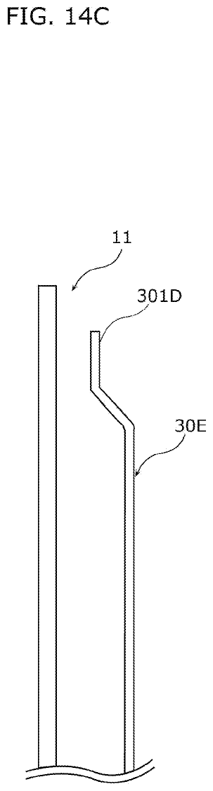

FIGS. 14A to 14C are examples of partial enlarged side views of the heat dissipation member and substrate 11 according to Variation 4. Elements identical to those in FIG. 2 and the like are given the same reference signs and will not be described in detail. To facilitate descriptions of the peripheral edges, heat dissipation member 30E and substrate 11 illustrated in FIGS. 14A to 14C are illustrated as having a more simplified shape than heat dissipation member 30 and substrate 11 illustrated in FIG. 2.

### Heat Dissipation Member 30E

The outer peripheral edge of heat dissipation member 30E illustrated in FIG. 14A will be described first.

Heat dissipation member 30E illustrated in FIG. 14A differs from heat dissipation member 30 illustrated in FIG. 2 in that the outer peripheral edge thereof is radially bent in the direction of substrate 11.

More specifically, as in Embodiment 1, heat dissipation member 30E illustrated in FIG. 14A is constituted by a plate member, is disposed opposite the second main surface of substrate 11, and is rotated along with substrate 11. Heat dissipation member 30E is a disk-shaped plate member rotationally driven by motor 40 about rotation axis J. In other words, the shape of heat dissipation member 30E is circular when seen in plan view.

Heat dissipation member 30E illustrated in FIG. 14A also has two fins formed in each of a plurality of regions, as described in Embodiment 1, Variation 1, or Variation 2. Heat dissipation member 30E may further have through-holes formed in the protrusion as described in Variation 3.

Heat dissipation member 30E illustrated in FIG. 14A further has bent edge part 301, which is formed by bending the outer peripheral edge of heat dissipation member 30E in the same direction as the direction in which the plurality of fins 31A and 31B and the like are flared from heat dissipation member 30E, and which is bent at an obtuse angle.

Bent edge part 301 is formed using a part of heat dissipation member 30E. More specifically, bent edge part 301 is formed by bending the outer peripheral edge part of heat dissipation member 30E in the same direction as the direction in which the plurality of fins 31A and 31B and the like are flared when viewed from heat dissipation member 30E, as illustrated in FIG. 14A, for example.

Here, when heat dissipation member 30E is cut in a straight line along radial direction r, bent edge part 301 has a radius bend shape, as illustrated in FIG. 14A, for example.

The outer peripheral edge of heat dissipation member 30E illustrated in FIG. 14B will be described next.

Heat dissipation member 30E illustrated in FIG. 14B differs from heat dissipation member 30 illustrated in FIG. 2 in that the outer peripheral edge thereof is bent at an angle (a C-bend) in the direction of substrate 11.

More specifically, as in Embodiment 1, heat dissipation member 30E illustrated in FIG. 14B is constituted by a plate member, is disposed opposite the second main surface of substrate 11, and is rotated along with substrate 11. Heat dissipation member 30E is a disk-shaped plate member rotationally driven by motor 40 about rotation axis J. In other words, the shape of heat dissipation member 30E is circular when seen in plan view.

Heat dissipation member 30E illustrated in FIG. 14B also has two fins formed in each of a plurality of regions, as described in Embodiment 1, Variation 1, or Variation 2. Heat dissipation member 30E may further have through-holes formed in the protrusion as described in Variation 3.

Heat dissipation member 30E illustrated in FIG. 14A further has bent edge part 301B, which is formed by bending the outer peripheral edge of heat dissipation member 30E in the same direction as the direction in which the plurality of fins 31A and 31B and the like are flared from heat dissipation member 30E, and which is bent at an obtuse angle.

Bent edge part 301B is formed using a part of heat dissipation member 30E. More specifically, bent edge part 301B is formed by bending the outer peripheral edge part of heat dissipation member 30E in the same direction as the direction in which the plurality of fins 31A and 31B and the like are flared when viewed from heat dissipation member 30E, as illustrated in FIG. 14B, for example.

Here, when heat dissipation member 30E is cut in a straight line along radial direction r, bent edge part 301B has an angular bend shape, as illustrated in FIG. 14B, for example.

The outer peripheral edge of heat dissipation member 30E illustrated in FIG. 14C will be described last.

Heat dissipation member 30E illustrated in FIG. 14C differs from heat dissipation member 30 illustrated in FIG. 2 in that the outer peripheral edge thereof has a Z-bend in the direction of substrate 11.

More specifically, as in Embodiment 1, heat dissipation member 30E illustrated in FIG. 14C is constituted by a plate member, is disposed opposite the second main surface of substrate 11, and is rotated along with substrate 11. Heat dissipation member 30E is a disk-shaped plate member rotationally driven by motor 40 about rotation axis J. In other words, the shape of heat dissipation member 30E is circular when seen in plan view.

Heat dissipation member 30E illustrated in FIG. 14C also has two fins formed in each of a plurality of regions, as described in Embodiment 1, Variation 1, or Variation 2. Heat dissipation member 30E may further have through-holes formed in the protrusion as described in Variation 3.

Heat dissipation member 30E illustrated in FIG. 14C further has bent edge part 301D, which is formed by bending the outer peripheral edge of heat dissipation member 30E in the same direction as the direction in which the plurality of fins 31A and 31B and the like are flared from heat dissipation member 30E, and which is bent at an obtuse angle.

Bent edge part 301D is formed using a part of heat dissipation member 30E. More specifically, bent edge part 301D is formed by bending the outer peripheral edge part of heat dissipation member 30E in the same direction as the direction in which the plurality of fins 31A and 31B and the like are flared when viewed from heat dissipation member 30E, as illustrated in FIG. 14C, for example.

Here, when heat dissipation member 30E is cut in a straight line along radial direction r, bent edge part 301D has a Z-bend shape, as illustrated in FIG. 14C, for example.

### Effects, Etc.

In this manner, phosphor wheel 1 according to the present variation may have a configuration in which the outer peripheral edge of heat dissipation member 30 has a radius bend, an angular bend, or a Z-bend, in addition to the configuration in which two fins are formed in each of the plurality of regions as disclosed in Embodiment 1, Variation 1, or Variation 2. Additionally, phosphor wheel 1 according to the present variation may be configured such that through-holes are formed in the protrusion.

### Embodiment 2

Embodiment 2 will describe a case where a shape element which applies knowledge of biomimetic techniques (a wind-catching shape) is added to the shape of the plurality of fins 31A and 31B and the like of phosphor wheel 1 according to Embodiment 1, Variation 1, Variation 2, Variation 3, or Variation 4.

The following will describe an example in which the thin, sharp shape element of an albatross wing is added to the shape of a fin as an example of a biomimetic application of the planar shape of a bird's wing.

Furthermore, the following will describe only the differences from fin 31A according to Embodiment 1, using an example in which the thin, sharp shape element of an albatross wing is added to the shape of fin 31A of the two fins 31A and 31B formed in each of the plurality of regions 32 of heat dissipation member 30 according to Embodiment 1. Note that the same applies not only when adding the shape element to the shape of fin 31B, but also when adding the shape element to the shape of the two fins formed in each of the plurality of regions of heat dissipation member 30 according to Variation 1, Variation 2, Variation 3, or Variation 4, and the descriptions thereof will therefore be omitted.

### Fin 31A According to Embodiment 2

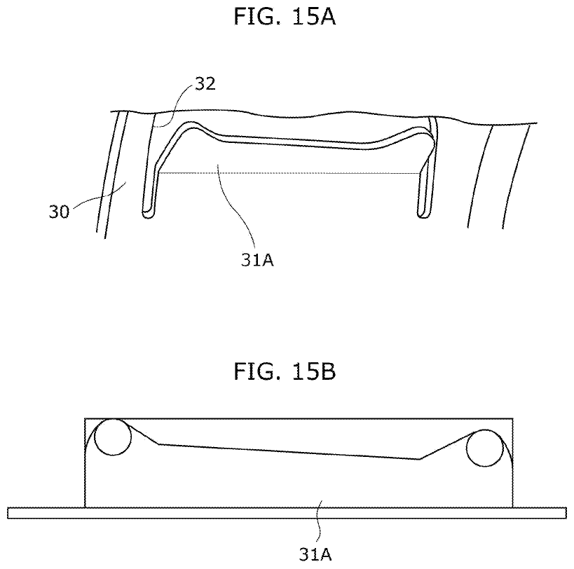

FIG. 15A is an enlarged view of fin 31A formed in one region 32 of heat dissipation member 30 according to Embodiment 2. Note that FIG. 15A illustrates only fin 31A of the two fins 31A and 31B formed in the one region 32, and fin 31B is not illustrated for the sake of simplicity.

Fin 31A according to Embodiment 2 and illustrated in FIG. 15A differs in shape from fin 31A according to Embodiment 1 and illustrated in FIGS. 5 to 7 in that a shape element applying knowledge of biomimetic techniques has been added.

An end of fin 31A according to Embodiment 2 is formed having at least one recessed part. In other words, the end of each of the plurality of fins 31A and 31B according to Embodiment 2 is formed having at least one recessed part.

More specifically, as illustrated in FIG. 15A, fin 31A according to Embodiment 2 is further formed having a recessed part in the end of fin 31A according to Embodiment 1 and illustrated in FIG. 7, for example. However, fin 31A according to Embodiment 2 is formed such that the area thereof is substantially the same as the area of fin 31A according to Embodiment 1. In other words, the height (length) of fin 31A according to Embodiment 2 from heat dissipation member 30 is higher (longer) than fin 31A according to Embodiment 1, with the exception of the recessed part. In addition, the recessed part is formed so as to have an incline, and the length of fin 31A according to Embodiment 2 in the recessed part is shortened along the incline.

Here, the recessed part of fin 31A according to Embodiment 2 is formed as a shape which is biomimetic of the thin, sharp shape element of an albatross wing (a wind-catching shape).

FIG. 15B is a diagram illustrating an example of the planar shape of fin 31A according to Embodiment 2.

Because fin 31A according to Embodiment 2 is also formed from a plate member, it is difficult to form fin 31A in a shape that directly reflects the shape of an albatross wing. Accordingly, in Embodiment 2, as a biomimetic of the shape element of the albatross wing, the recessed part having an incline is formed in the upper end of fin 31A when the fin is lanced, creating a shape in which the length of fin 31A from the lower end to the upper end decreases along the incline, as illustrated in FIG. 15B. Note that the shape of fin 31A illustrated in FIG. 15A is an example of a shape that can be machined. In other words, the thin, sharp shape element of an albatross wing can be considered to be a shape that gradually narrows toward one end, and forming the recessed part having an incline in fin 31A as illustrated in the example in FIG. 15B produces a shape in fin 31A in which the length from the lower end to the upper end decreases gradually.

### Effects, Etc.

According to the present embodiment, the plurality of fins 31A and 31B are formed by lancing a plurality of regions in a peripheral region outside the central part of heat dissipation member 30, similar to fins 31A and 31B according to Embodiment 1. Furthermore, the end of each of the plurality of fins 31A and 31B according to the present embodiment is formed having at least one recessed part. The recessed part is formed so as to have an incline, and the length of the fin in the recessed part is shortened along the incline.

This makes it possible for each of the plurality of fins 31A and 31B according to the present embodiment to suppress blowing noise.

Incidentally, when an object moves, the flow of air is disturbed by the movement, and a vortex which changes constantly is produced behind the object. It is thought that sound is produced when the force of this vortex acts on the object and a reaction force therefrom acts on air. Therefore, reducing this vortex and suppressing air turbulence (vortex turbulence) makes it more likely that sound produced by the movement of the object can be suppressed.

Meanwhile, the albatross is known to have wings which provide the highest gliding power of all birds and which are therefore suitable for long-distance flight. The wing of an albatross has a planar shape with a large aspect ratio (thin and sharp) that suppresses induced drag when gliding. In view of this, the wing of an albatross is likely to produce fewer vortices and less air turbulence when gliding.

Therefore, by making the shape of each of the plurality of fins 31A and 31B according to the present embodiment a biomimetic shape of the shape element of the wing of a bird such as an albatross, it may be possible to reduce vortices and air turbulence caused by the rotation of the plurality of fins 31A and 31B together with heat dissipation member 30.

Although the foregoing describes each of the plurality of fins 31A and 31B according to the present embodiment as having a recessed part at the upper end thereof, the configuration is not limited thereto. The recessed part described above may be formed in each of the plurality of fins 31A and 31B according to the present embodiment at the left end and/or the right end thereof.

### Variation

Next, a variation on Embodiment 2 will be described in which a shape element of the wing of the chestnut tiger butterfly is added to the fin shape as an example of biomimetic application of the planar shape of a butterfly wing.

Furthermore, the following will describe only the differences from fin 31A according to Embodiment 1, using an example in which the shape element of a chestnut tiger butterfly wing is added to the shape of fin 31A of the two fins 31A and 31B formed in each of the plurality of regions 32 of heat dissipation member 30 according to Embodiment 1. Note that the same applies not only when adding the shape element to the shape of fin 31B, but also when adding the shape element to the shape of the two fins formed in each of the plurality of regions of heat dissipation member 30 according to Variation 1, Variation 2, Variation 3, or Variation 4, and the descriptions thereof will therefore be omitted.

### Fin 31A According to Variation on Embodiment 2

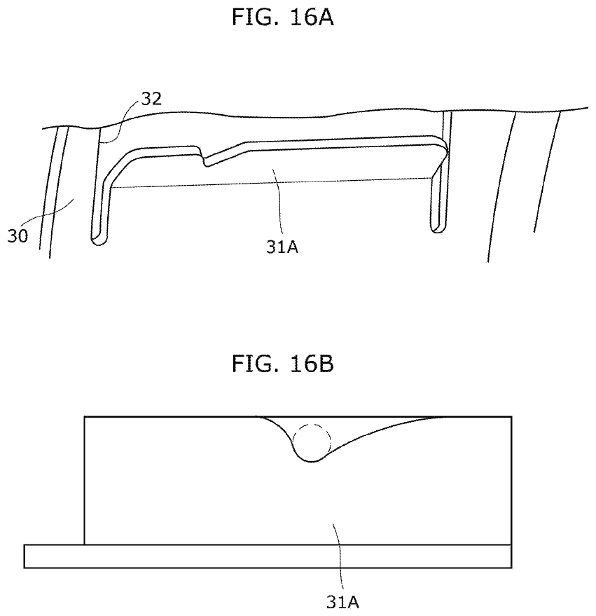

FIG. 16A is an enlarged view of fin 31A formed in one region 32 of heat dissipation member 30 according to the variation on Embodiment 2. Note that FIG. 16A illustrates only fin 31A of the two fins 31A and 31B formed in the one region 32, and fin 31B is not illustrated for the sake of simplicity.

Fin 31A according to Embodiment 2 and illustrated in FIG. 16A differs in shape from fin 31A according to Embodiment 1 and illustrated in FIGS. 5 to 7 in that a shape element applying knowledge of biomimetic techniques has been added.

An end of fin 31A according to the variation on Embodiment 2 is formed having at least one recessed part. In other words, the end of each of the plurality of fins 31A and 31B according to Embodiment 2 is formed having at least one recessed part.

More specifically, as illustrated in FIG. 16A, fin 31A according to the variation on Embodiment 2 is further formed having a recessed part in the end of fin 31A according to Embodiment 1 and illustrated in FIG. 7, for example. The recessed part is formed in a position offset toward one side from a center of the end. However, fin 31A according to the variation on Embodiment 2 is formed such that the area thereof is relatively smaller than the area of fin 31A according to Embodiment 1.

Here, the recessed part in fin 31A according to the variation on Embodiment 2 is formed as a shape biomimetic of the shape element of the wing of the butterfly called the chestnut tiger butterfly (a wind-catching shape).

FIG. 16B is a diagram illustrating an example of the planar shape of fin 31A according to the variation on Embodiment 2.

Because fin 31A according to the variation on Embodiment 2 is also formed from a plate member, it is difficult to form fin 31A in a shape that directly reflects the shape of the wing of a chestnut tiger butterfly. Accordingly, in the present variation, the shape element of the chestnut tiger butterfly is biomimetic and, as illustrated in FIG. 16B, the recessed part is formed in the upper end of fin 31A when the fin is lanced, creating a shape in which a notch is formed near the center of the upper end of fin 31A. Note that the shape of fin 31A illustrated in FIG. 16A is an example of a shape that can be machined. In other words, the shape element of a chestnut tiger butterfly wing can be considered to be a shape that has a notch formed near the center, and forming the recessed part in a position offset to the right from the center of fin 31A as illustrated in the example in FIG. 16B produces a shape in fin 31A in which a notch is formed near the center thereof.

### Effects, Etc.

According to the present variation, the plurality of fins 31A and 31B are formed by lancing a plurality of regions in a peripheral region outside the central part of heat dissipation member 30, similar to fins 31A and 31B according to Embodiment 1. Furthermore, the end of each of the plurality of fins 31A and 31B formed in heat dissipation member 30 according to the present variation is formed having at least one recessed part. The recessed part is formed offset from the center of the end in one direction (that is, to the left or the right).

This makes it possible for each of the plurality of fins 31A and 31B according to the present variation to suppress blowing noise.

Incidentally, the chestnut tiger butterfly is known to fly long distances, including being able to cross oceans, without flapping its wings at a high rate. Although the flight capabilities of the chestnut tiger butterfly are unknown at present, the wings of the chestnut tiger butterfly have a planar shape with a distinctive notch near the center. In view of this, the wing of the chestnut tiger butterfly is likely to produce fewer vortices and less air turbulence during flight.

Therefore, by making the shape of each of the plurality of fins 31A and 31B according to the present variation a biomimetic shape of the shape element of the wing of a butterfly such as a chestnut tiger butterfly, it may be possible to reduce vortices and air turbulence caused by the rotation of the plurality of fins 31A and 31B together with heat dissipation member 30.

Although the foregoing describes each of the plurality of fins 31A and 31B according to the present variation as having a recessed part at the upper end thereof, the configuration is not limited thereto. The recessed part described above may be formed in each of the plurality of fins 31A and 31B at the left end and/or the right end thereof.

### Other Embodiments, Etc.

It goes without saying that the above-described embodiments and variations are merely examples, and that various changes, additions, omissions, and the like are possible.

Aspects realized by combining the constituent elements and functions described in the foregoing embodiments and variations as desired are also included in the scope of the present disclosure.

Additionally, embodiments achieved by one skilled in the art making various conceivable variations on the embodiments and variations, embodiments achieved by combining constituent elements and functions from the embodiments as desired within a scope which does not depart from the spirit of the present disclosure, and the like are also included in the present disclosure. For example, the constituent elements described in the embodiments and variations can also be combined in order to achieve new embodiments.

Additionally, the constituent elements indicated in the accompanying drawings and the detailed descriptions include not only constituent elements necessary to solve the technical problem, but also constituent elements not necessary to solve the problem but used to exemplify the above-described technique. Those unnecessary constituent elements being included in the accompanying drawings, the detailed description, and so on should therefore not be interpreted as meaning that the unnecessary constituent elements are in fact necessary.

The present disclosure further includes a light source device or laser projector constituted by a phosphor wheel, as described hereinafter.

In other words, the present disclosure also includes a light source device including a phosphor wheel described in the foregoing embodiments and variations, an excitation light source such as a laser light source, and an optical system that guides light emitted from the excitation light source to the phosphor wheel. The present disclosure also includes a projection-type image display device including a phosphor wheel described in the foregoing embodiments and variations, a motor that rotates the phosphor wheel, a laser light source that emits laser light onto the phosphor layer, a light modulation element that modulates light emitted from the phosphor layer in response to the laser light emitted from the laser light source based on an image signal, and a projection lens that projects the light modulated by the light modulation element.

### Supplementary Notes

The following inventions are disclosed by the descriptions in the foregoing embodiments.

(Invention 1) A phosphor wheel according to the present disclosure including: a substrate having a first main surface and a second main surface which face in opposite directions; a phosphor layer provided on the first main surface; and a heat dissipation member constituted by a plate member, the heat dissipation member being disposed opposite the second main surface and rotating along with the substrate. The heat dissipation member includes: a protrusion provided in a central part of the heat dissipation member and protruding toward the second main surface, the protrusion having a contact surface that contacts the second main surface; and a plurality of fins formed by lancing a plurality of regions in a peripheral region outside the central part. The protrusion provides a set gap between the substrate and the heat dissipation member and conducts heat from the substrate to the peripheral region of the heat dissipation member by contacting the substrate with the contact surface. Two fins among the plurality of fins are formed in each of the plurality of regions, and the two fins are formed on sides, of a corresponding one of the plurality of regions, that are opposite each other in a rotation direction of the heat dissipation member.

As a result, wind produced by the plurality of fins can be pushed out of the plurality of regions (through-holes) toward the outside of the space between the substrate and the heat dissipation member. In other words, wind produced by the plurality of fins can be used to cool the phosphor layer.

Furthermore, having the substrate and the protrusion contact each other makes it possible to form a heat conduction path that conducts heat produced in the phosphor layer from the substrate to the peripheral region of the heat dissipation member, which improves the heat dissipation performance. Furthermore, the two fins are formed on opposite sides of the corresponding one of the plurality of regions, and thus the area of the plurality of fins located near the surface of the substrate increases. This accelerates the dissipation of heat due to convection on the substrate, which makes it possible to reduce the temperature of the phosphor layer.

(Invention 2) The phosphor wheel according to Invention 1, wherein one of the two fins has substantially a same size as an other of the two fins.

(Invention 3) The phosphor wheel according to Invention 1, wherein one of the two fins is larger than an other of the two fins.

(Invention 4) The phosphor wheel according to any one of Invention 1 to Invention 3, wherein each of the plurality of fins is flared toward the second main surface. This configuration makes it possible to further accelerate the flow of fluid (air) produced between the phosphor layer and the heat dissipation member, which makes it possible to further reduce the temperature of the phosphor layer.

(Invention 5) The phosphor wheel according to any one of Inventions 1 to 4, wherein the phosphor layer is provided in a band shape and an annular shape on the first main surface, and a diameter of the heat dissipation member is smaller than an outer diameter of the phosphor layer and larger than an inner diameter of the phosphor layer.

(Invention 6) The phosphor wheel according to any one of Inventions 1 to 5, wherein a bent edge part formed by bending an outer peripheral edge of the heat dissipation member in a same direction as a direction in which the plurality of fins are flared from the heat dissipation member, the bent edge part being bent at an obtuse angle. This configuration makes it possible to further accelerate the flow of fluid (air) produced between the phosphor layer and the heat dissipation member, which makes it possible to further reduce the temperature of the phosphor layer.

(Invention 7) The phosphor wheel according to Invention 6, wherein when cut along a straight line parallel to a radial direction of the heat dissipation member, the bent edge part has a radius bend shape.

(Invention 8) The phosphor wheel according to Invention 6, wherein when cut along a straight line parallel to a radial direction of the heat dissipation member, the bent edge part has a Z-bend shape.

(Invention 9) The phosphor wheel according to Invention 6, wherein when cut along a straight line parallel to a radial direction of the heat dissipation member, the bent edge part has an angular bend shape.

(Invention 10) The phosphor wheel according to any one of Inventions 1 to 9, wherein the protrusion includes a peripheral wall having the contact surface as a base surface, and the peripheral wall includes a plurality of through-holes formed for ventilation. This configuration makes it possible to further accelerate the flow of fluid (air) produced between the phosphor layer and the heat dissipation member, which makes it possible to further reduce the temperature of the phosphor layer.

(Invention 11) The phosphor wheel according to Invention 10, wherein each of the plurality of through-holes is formed across a boundary between the peripheral wall and the contact surface.

(Invention 12) The phosphor wheel according to Invention 10, wherein each of the plurality of through-holes is formed only in the peripheral wall, and is formed in what is a center of the peripheral wall when viewed in a direction from the heat dissipation member toward the contact surface.

(Invention 13) The phosphor wheel according to any one of Inventions 10 to 12, wherein each of the plurality of through-holes is formed in a position different from regions connecting a rotation axis of the heat dissipation member to respective ones of the plurality of fins. This configuration makes it possible to further accelerate the flow of fluid (air) produced between the phosphor layer and the heat dissipation member, which makes it possible to further reduce the temperature of the phosphor layer.

(Invention 14) The phosphor wheel according to any one of Inventions 1 to 13, wherein a plurality of holes are formed in each of the plurality of fins. This configuration makes it possible to further accelerate the flow of fluid (air) produced between the phosphor layer and the heat dissipation member, which makes it possible to further reduce the temperature of the phosphor layer.

(Invention 15) The phosphor wheel according to any one of Inventions 1 to 14, wherein the substrate is disk-shaped, and the phosphor layer is formed as a band along a circumferential direction of the substrate.

(Invention 16) The phosphor wheel according to any one of Invention 1 to 15, wherein an end of each of the plurality of fins is formed having at least one recessed part. This configuration may make it possible for each of the plurality of fins to suppress blowing noise.

(Invention 17) The phosphor wheel according to Invention 16, wherein the recessed part is formed in a position offset toward one side from a center of the end. This configuration may make it possible for each of the plurality of fins to reduce vortices and air turbulence that can be caused by the rotation of the plurality of fins together with the heat dissipation member, and may therefore be capable of reducing blowing noise.

(Invention 18) The phosphor wheel according to Invention 16, wherein the recessed part is formed having an incline, and a length of each of the plurality of fins in the at least one recessed part decreases along the incline. This configuration may make it possible for each of the plurality of fins to reduce vortices and air turbulence that can be caused by the rotation of the plurality of fins together with the heat dissipation member, and may therefore be capable of reducing blowing noise.

1. A phosphor wheel comprising:
a substrate having a first main surface and a second main surface which face in opposite directions;
a phosphor layer provided on the first main surface; and
a heat dissipation member constituted by a plate member, the heat dissipation member being disposed opposite the second main surface and rotating along with the substrate,
wherein the heat dissipation member includes:
a protrusion provided in a central part of the heat dissipation member and protruding toward the second main surface, the protrusion having a contact surface that contacts the second main surface; and
a plurality of fins formed by lancing a plurality of regions in a peripheral region outside the central part,
the protrusion provides a set gap between the substrate and the heat dissipation member and conducts heat from the substrate to the peripheral region of the heat dissipation member by contacting the substrate with the contact surface,
two fins among the plurality of fins are formed in each of the plurality of regions, and
the two fins are formed on sides, of a corresponding one of the plurality of regions, that are opposite each other in a rotation direction of the heat dissipation member.

2. The phosphor wheel according to claim 1,
wherein one of the two fins has substantially a same size as an other of the two fins.

3. The phosphor wheel according to claim 1,
wherein one of the two fins is larger than an other of the two fins.

4. The phosphor wheel according to claim 1,
wherein each of the plurality of fins is flared toward the second main surface.

5. The phosphor wheel according to claim 1,
wherein the phosphor layer is provided in a band shape and an annular shape on the first main surface, and
a diameter of the heat dissipation member is smaller than an outer diameter of the phosphor layer and larger than an inner diameter of the phosphor layer.

6. The phosphor wheel according to claim 1, further comprising:
a bent edge part formed by bending an outer peripheral edge of the heat dissipation member in a same direction as a direction in which the plurality of fins are flared from the heat dissipation member, the bent edge part being bent at an obtuse angle.

7. The phosphor wheel according to claim 6,
wherein when cut along a straight line parallel to a radial direction of the heat dissipation member, the bent edge part has a radius bend shape.

8. The phosphor wheel according to claim 6,
wherein when cut along a straight line parallel to a radial direction of the heat dissipation member, the bent edge part has a Z-bend shape.

9. The phosphor wheel according to claim 6,
wherein when cut along a straight line parallel to a radial direction of the heat dissipation member, the bent edge part has an angular bend shape.

10. The phosphor wheel according to claim 1,
wherein the protrusion includes a peripheral wall having the contact surface as a base surface, and the peripheral wall includes a plurality of through-holes formed for ventilation.

11. The phosphor wheel according to claim 10,
wherein each of the plurality of through-holes is formed across a boundary between the peripheral wall and the contact surface.

12. The phosphor wheel according to claim 10,
wherein each of the plurality of through-holes is formed only in the peripheral wall, and is formed in what is a center of the peripheral wall when viewed in a direction from the heat dissipation member toward the contact surface.

13. The phosphor wheel according to claim 10,
wherein each of the plurality of through-holes is formed in a position different from regions connecting a rotation axis of the heat dissipation member to respective ones of the plurality of fins.

14. The phosphor wheel according to claim 1,
wherein a plurality of holes are formed in each of the plurality of fins.

15. The phosphor wheel according to claim 1,
wherein the substrate is disk-shaped, and
the phosphor layer is formed as a band along a circumferential direction of the substrate.

16. The phosphor wheel according to claim 1,
wherein an end of each of the plurality of fins is formed having at least one recessed part.

17. The phosphor wheel according to claim 16,
wherein the recessed part is formed in a position offset toward one side from a center of the end.

18. The phosphor wheel according to claim 16,
wherein the recessed part is formed having an incline, and
a length of each of the plurality of fins in the at least one recessed part decreases along the incline.
